(19) United States
(12) Patent Application Publication
(10) Pub. No.: US 2023/0223529 A1
(43) Pub. Date: Jul. 13, 2023

(54) PROCESS FOR MAKING AN ELECTRODE, AND ELECTRODE ACTIVE MATERIALS

(71) Applicant: BASF SE, Ludwigshafen Am Rhein (DE)

(72) Inventors: Yohko TOMOTA, Amagasaki (JP); Christoph ERK, Amagasaki (DE); Pascal HARTMANN, Ludwigshafen (DE)

(21) Appl. No.: 17/999,218

(22) PCT Filed: Jun. 7, 2021
(86) PCT No.: PCT/EP2021/065172

§ 371 Date: Nov. 18, 2022

(30) Foreign Application Priority Data
Jun. 16, 2020 (EP) 20180372.3

(51) Int. Cl. H01M 4/525; H01M 4/04; H01M 4/36; H01M 4/505; H01M 4/62; H01M 4/583; H01M 10/0562

(52) U.S. Cl. CPC H01M 4/525; H01M 4/043; H01M 4/364; H01M 4/505; H01M 4/622; H01M 4/583; H01M 10/0562; H01M 2004/027

(57) ABSTRACT

The present invention is directed towards a process for making an electrode wherein the process comprises the following steps (a) providing a particulate lithiated transition metal oxide according to the formula Li₁₊ₓTM₁₋ₓO₂ wherein x is in the range of from zero to 0.1 and TM contains nickel and at least one of Co, Mn and Al, (b) mixing the lithiated transition metal oxide from step (a) with carbon in electrically conductive form, (c) exposing the mixture obtained in step (b) to a pressure in the range of from 100 to 500 MPa over a period of time of from one second to one minute, thereby causing cracks in at least some of the particles of the electrode active material, (d) mixing the mixture from step (c) with a binder polymer and, optionally, with further carbon in electrically conductive form and with a solvent, (e) applying the mixture from step (d) to a metal foil.

The present invention is directed towards a process for making an electrode wherein the process comprises the following steps
(a) providing a particulate lithiated transition metal oxide according to the formula Li₁₋ₓTM₁₋ₓO₂ wherein x is in the range of from zero to 0.1 and TM contains nickel and at least one of Co, Mn and Al,
(b) mixing the lithiated transition metal oxide from step (a) with carbon in electrically conductive form,
(c) exposing the mixture obtained in step (b) to a pressure in the range of from 100 to 500 MPa over a period of time of from one second to one minute, thereby causing cracks in at least some of the particles of the electrode active material,
(d) mixing the mixture from step (c) with a binder polymer and, optionally, with further carbon in electrically conductive form and with a solvent,
(e) applying the mixture from step (d) to a metal foil.

Additionally, the present invention is directed to electrode active materials.

Lithiated transition metal oxides are currently being used as electrode active materials for lithium-ion batteries. Extensive research and developmental work have been performed in the past to improve properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—generally also referred to as thermal treatment or heat treatment of the precursor—is usually carried out at temperatures in the range of from 600 to 1000° C. During the thermal treatment a solid-state reaction takes place, and the electrode active material is formed. The thermal treatment is performed in the heating zone of an oven or kiln.

An ongoing issue remains the problem of capacity fade. Various theories exist about the reason for the capacity fade, and—among others—the surface properties the cathode active materials have been modified, for example by coating with an inorganic oxide or with polymers. All of the suggested solutions leave room for improvement. Various theories have been developed with respect to the reason for such capacity fade upon repeated cycling. One of those theories is related to crack formation and attempts to prevent crack formation, for example by coating methods, US 2017/0104217, by tungsten oxide addition into the particle interspace EP 3 553 856, or by specific co-precipitation conditions, US 2018/0166687. All said references teach to avoid crack formation but leave room for improvement.

It was therefore an objective of the present invention to provide electrodes with low capacity fading and thus a high cycling stability. It was further an objective to provide a process for making such electrodes with both a low capacity fading and thus a high cycling stability. It was further an objective to provide electrode active materials with low capacity fading and thus a high cycling stability.

Accordingly, the process defined at the outset has been found, hereinafter also referred to as inventive process or process according to the present invention.

The inventive process comprises the following steps (a) to (e), hereinafter also referred to as step (a) or step (b) or step (c) or step (d) or step (e), or briefly as (a) or (b) or (c) or (d) or (e), respectively: Steps (a) to (e) will be described hereinafter in more detail below.

Step (a) starts off from a lithiated transition metal oxide according to the general formula Li₁₊ₓTM₁₋ₓO₂ wherein x is in the range of from zero to 0.1, from zero to 0.1, preferably 0.01 to 0.05, and TM contains nickel and at least one of Co, Mn and Al.

Said TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

In one embodiment of the present invention lithiated transition metal oxide according to general formula Li₁₋ₓTM₁₋ₓO₂ has an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In one embodiment of the present invention, the primary particles of lithiated transition metal oxide according to general formula Li₁₊ₓTM₁₋ₓO₂ have an average diameter (D50) in the range from 1 to 2000 nm, preferably from 10 to 1000 nm, particularly preferably from 50 to 500 nm. The average primary particle diameter can, for example, be determined by SEM or TEM, or by LASER scattering.

In one embodiment of the present invention, TM is a combination of transition metals according to general formula (I)

(NiₐCo_{b}Mn_{c})_{1-d}M¹_{d} (I)

wherein
a is in the range of from 0.6 to 1.0, preferably 0.7 to 0.9, and more preferably 0.75 to 0.85,
b being in the range of from zero to 0.2, preferably 0.05 to 0.2,
c being in the range of from zero to 0.2, preferably 0.01 to 0.1, and
d being in the range of from zero to 0.1, preferably 0.001 to 0.005,

M¹ is selected from Al, Ti, Zr, W, Nb, Ta, Mo, Mg and combinations of at least two of the aforementioned, of which Al and Ti and Zr and combinations of at least two of the aforementioned are preferred,

a+b+c=1, and

at least one of b, c and d is greater than zero.

In one embodiment of the present invention, lithiated transition metal oxide provided in step (a) have a specific surface (BET), hereinafter also referred to as “BET surface”, in the range of from 0.1 to 1.0 m²/g. The BET surface may be determined by nitrogen adsorption after outgassing of the sample at 200° C. for 30 minutes and, beyond this, according to DIN-ISO 9277:2003-05.

In step (b), the above lithiated transition metal oxide is mixed with carbon in electrically conductive form, hereinafter also referred to as carbon (B). Carbon (B) can be selected from soot, active carbon, carbon nanotubes, graphene, and graphite. Carbon (B) can be added as such during the inventive process. A preferred carbon (B) is graphite.

In step (b), no binder (C) is added or present. Binders (C)— also referred to as binder polymers (C)— are described in more detail below.

In step (b), it is preferred to mix lithiated transition metal oxide with carbon (B) wherein the quantities of carbon (B) are lower than of the lithiated transition metal oxide. Preferably, in step (b), the weight ratio of lithiated transition metal oxide provided in step (a) and carbon (B) is in the range of from 100:1 to 20:1, preferably 60:1 to 25:1.

In one embodiment of the present invention, the average particle diameter of carbon (B) in step (b) is in the range of from 1 to 20 μm. Preferably, carbon (B) is selected from synthetic graphite with platelet-shaped secondary particles.

In one embodiment of the present invention, the mixing in step (b) is performed in a high-shear mixer, in a plough-share mixer, in a free-fall mixer, or in a ball mill. On laboratory scale, shakers and roller mixers are suitable as well. On laboratory scale, mortars with pestles are useful as well.

In step (c), the mixture obtained in step (b) is exposed to a pressure in the range of from 100 to 500 MPa, preferably 120 to 350 MPa, thereby causing cracks in at least some of the particles of the electrode active material. The crack level is in the range of from 5 to 30, preferably at least 20 and refers to at least 25% of all particles of the respective electrode active material.

Step (c) may be performed in various types of vessels. Suitable are, for example, isostatic pressing devices. Isostatic pressing devices may be selected from so-called “cold” isostatic pressing devices and “hot” isostatic pressing devices, and they are known from the formation of green bodies of ceramics, and from the casting industry. On laboratory scale, tablet presses are useful as well.

In one embodiment of the present invention, step (c) is performed at a temperature in the range of from 10 to 50° C. It is possible to perform external cooling during step (c). Preferably, step (c) is performed without external heating or cooling.

The duration of step (c) is in the range of from one second to one minute, preferably 5 to 30 seconds.

In the course of step (c), cracks are formed in the particles of lithiated transition metal oxide. The cracks may be detected by SEM (Scanning Electron Microscopy), and the crack level is determined as follows: the SEM picture is analyzed by an edge detection algorithm, which computes the gradient of image intensity and thus detects the cracks.

Such cracks may have any shape. They may follow primary particles but not affect them. In an alternative embodiment, cracks may affect primary particles as well. Preferably, such cracks affect secondary particles but not primary particles. Cracks may be in one direction only or may display turns, for example, they may be zig-zag shaped.

In the subsequent step (d), the mixture from step (c) is mixed with a binder polymer (C) and, optionally, with further carbon in electrically conductive form, carbon (B), and with a solvent.

Cathodes according to the present invention contain carbon in electrically conductive modification, in brief also referred to as carbon (B). Carbon (B) can be selected from soot, active carbon, carbon nanotubes, graphene, and graphite. Carbon (B) can be added as such during preparation of electrode materials according to the invention.

Electrodes according to the present invention can comprise further components. They can comprise a current collector (D), such as, but not limited to, an aluminum foil. They further comprise a binder polymer (C), hereinafter also referred to as binder (C). Current collector (D) is not further described here.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Suitable solvents that may be added are organic non-protic solvents such as N-methyl pyrrolidone (NMP), N-ethyl pyrrolidone (NEP), dimethyl sulfoxide (DMSO), aromatic hydrocarbons such as, but not limited to toluene and ethylbenzene and xylene, for example m-xylene and o-xylene and mixtures of the isomers of xylene.

In a preferred embodiment of the present invention, the amounts of carbon (B) and binder polymer (C) are selected as follows:

(A) 80 to 99% by weight cathode active material obtained from step (c),
(B) 0.5 to 19.5% by weight of carbon,
(C) 0.5 to 9.5% by weight of binder polymer,
percentages referring to the sum of (A), (B) and (C).

The amount of solvent—if applicable—is selected that a slurry or paste is formed, for example 25% by weight up to the 10-fold of the sum of cathode active material obtained from step (c) and carbon (B) and binder polymer (C).

Mixing may be performed in any suitable vessel. Mixing is preferably performed until a lump-free slurry or paste is obtained.

In step (e), the mixture obtained from step (e) is applied to a metal foil, for example an aluminium foil. Such metal foil then serves as a current collector. Said applying includes placing slurry or paste from step (d) on said metal foil, for example by spraying or by dipping or by a doctor blade or with a squeegee, securing the layer of slurry or paste from step (d) to have a homogeneous thickness, and removing the solvent—if present—for example by drying under reduced pressure.

Step (e) may further include a calendaring step.

Cathodes made according to the inventive process are excellent components for electrochemical cells and especially for lithium ion batteries.

Another aspect of the present invention is related to electrode active materials, hereinafter also referred to as inventive electrode active materials or inventive cathode active materials. Inventive electrode materials may be manufactured in accordance with the inventive process. Inventive electrode materials are described in more detail below.

Inventive electrode materials are characterized in that they are particulate electrode active material according to the formula Li₁₊ₓTM₁₋ₓO₂ wherein x is in the range of from zero to 0.1, preferably 0.01 to 0.05, and TM contains nickel and at least one of Co, Mn and Al, for example Ni, Co and Al or Ni, Co and Mn, or Ni, Mn and Al, and wherein at least 25% of all particles having a crack level of at least 5, for example is in the range of from 5 to 30, and wherein such cracks contain carbon in electrically conductive form.

In one embodiment of the present invention inventive electrode active materials have an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In one embodiment of the present invention, the primary particles of inventive electrode active materials have an average diameter (D50) in the range from 1 to 2000 nm, preferably from 10 to 1000 nm, particularly preferably from 50 to 500 nm. The average primary particle diameter can, for example, be determined by SEM or TEM, or by LASER scattering.

In one embodiment of the present invention, TM in the formula Li₁₊ₓTM₁₋ₓO₂ is a combination of elements according to general formula (I)

(NiₐCo_{b}Mn_{c})_{1-d}M¹_{d} (I)

wherein
a is in the range of from 0.6 to 1.0, preferably 0.7 to 0.9, and more preferably 0.75 to 0.85,
b being in the range of from zero to 0.2, preferably 0.05 to 0.2,
c being in the range of from zero to 0.2, preferably 0.01 to 0.1, and
d being in the range of from zero to 0.1, preferably 0.001 to 0.005,

M¹ is selected from Al, Ti, Zr, W, Nb, Ta, Mo, Mg and combinations of at least two of the aforementioned, of which Al and Ti and Zr and combinations of at least two of the aforementioned are preferred,

and

a+b+c=1.

Inventive electrode active materials are further characterized in that at least 25% of the particles have a crack level of at least 5, for example in the range of from 5 to 30, preferably of at least 20, and such cracks contain carbon in electrically conductive form, preferably graphite. The cracks may be detected by SEM (Scanning Electron Microscopy), and the crack level is determined as follows: the respective SEM picture is analyzed by an edge detection algorithm, which computes the gradient of image intensity and thus detects the cracks.

In one embodiment of the present invention, inventive electrode active materials have a specific surface (BET) in the range of from 0.1 to 1.0 m²/g. The BET surface may be determined by nitrogen adsorption after outgassing of the sample at 200° C. for 30 minutes and, beyond this, according to DIN-ISO 9277:2003-05.

In one embodiment of the present invention, inventive electrode active materials the weight ratio of lithiated transition metal oxide provided and carbon (B) is in the range of from 100:1 to 20:1, preferably 60:1 to 25:1.

The cracks usually do not contain binder polymer (C).

A further aspect of the present invention is an electrochemical cell, containing
(1) a cathode comprising inventive electrode active material (A), carbon (B), and binder (C),
(2) an anode, and
(3) at least one electrolyte.

Embodiments of cathode (1) have been described above in detail.

Anode (2) may contain at least one anode active material, such as carbon (graphite), TiO₂, lithium titanium oxide, silicon or tin. Anode (2) may additionally contain a current collector, for example a metal foil such as a copper foil.

Electrolyte (3) may comprise at least one non-aqueous solvent, at least one electrolyte salt and, optionally, additives.

Non-aqueous solvents for electrolyte (3) can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and, in particular, 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

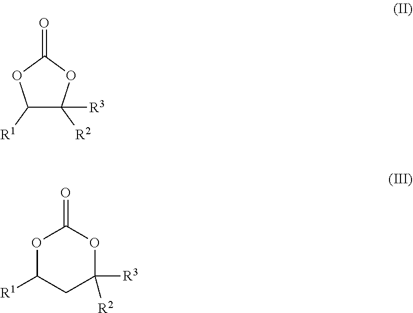

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

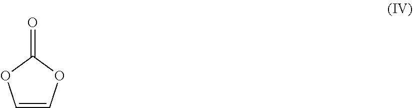

The solvent or solvents is/are preferably used in the water-free state, i.e. with a water content in the range from 1 ppm to 0.1% by weight, which can be determined, for example, by Karl-Fischer titration.

Electrolyte (3) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CnF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:

t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In a preferred embodiment of the present invention, electrolyte (3) contains at least one flame retardant. Useful flame retardants may be selected from trialkyl phosphates, said alkyl being different or identical, friaryl phosphates, alkyl dialkyl phosphonates, and halogenated trialkyl phosphates. Preferred are tri-C₁-C₄-alkyl phosphates, said C₁-C₄-alkyls being different or identical, tribenzyl phosphate, triphenyl phosphate, C₁-C₄-alkyl di-C₁-C₄-alkyl phosphonates, and fluorinated tri-C₁-C₄-alkyl phosphates,

In a preferred embodiment, electrolyte (3) comprises at least one flame retardant selected from trimethyl phosphate, CH₃—P(O)(OCH₃)₂, triphenylphosphate, and tris-(2,2,2-trifluoroethyl)phosphate.

Electrolyte (3) may contain 1 to 10% by weight of flame retardant, based on the total amount of electrolyte.

In one embodiment of the present invention, electrolyte (3) is solid at ambient temperature and contains sulfur and phosphorus, hereinafter also referred to as solid electrolyte (3).

In this context, the term “solid” refers to the state of matter at ambient temperature.

In one embodiment of the present invention, solid electrolyte (3) has a lithium-ion conductivity at 25° C. of ≥0.1 mS/cm, preferably in the range of from 0.1 to 30 mS/cm, measurable by, e.g., impedance spectroscopy.

In one embodiment of the present invention, solid electrolyte (3) comprises Li₃PS₄, yet more preferably orthorhombic β-Li₃PS₄.

In one embodiment of the present invention, solid electrolyte (3) is selected from the group consisting of Li₂S—P₂S₅, Li₂S—P₂S₅—LiI, Li₂S—P₂S₅—Li₂O, Li₂S—P₂S₅—Li₂O—LiI, Li₂S—SiS₂—P₂S₅—LiI, Li₂S—P₂S₅—ZₘSₙ wherein m and n are positive numbers and Z is a member selected from the group consisting of germanium, gallium and zinc, Li₂S—SiS₂—Li₃PO₄, Li₂S—SiS₂—Li_{y}PO_{z}, wherein y and z are positive numbers, Li₇P₃S₁₁, Li₃PS₄, Li₁₁S₂PS₁₂, Li₇P₂S₈I, and Li₇₋ᵣ₋₂ₛPS₆₋ᵣ₋ₛX¹ᵣ wherein X¹ is chlorine, bromine or iodine, and the variables are defined as follows:

0.8≤r≤1.7

0≤s≤(−0.25r)+0.5.

A particularly preferred example of solid electrolytes (3) is Li₆PS₅Cl, thus, r=1.0 and s=zero.

In one embodiment of the present invention, solid electrolyte (3) is doped with at least one of Si, Sb, Sn. Si is preferably provided as element. Sb and Sn are preferably provided as sulfides.

In an embodiment of the present invention, batteries according to the invention comprise one or more separators (4) by means of which the electrodes are mechanically separated. Suitable separators (4) are polymer films, in particular porous polymer films, which are unreactive toward metallic lithium. Particularly suitable materials for separators (4) are polyolefins, in particular film-forming porous polyethylene and film-forming porous polypropylene.

Separators (4) composed of polyolefin, in particular polyethylene or polypropylene, can have a porosity in the range from 35 to 50%. Suitable pore diameters are, for example, in the range from 30 to 500 nm.

In another embodiment of the present invention, separators (4) can be selected from among PET nonwovens filled with inorganic particles. Such separators can have a porosity in the range from 40 to 55%. Suitable pore diameters are, for example, in the range from 80 to 750 nm.

Batteries according to the invention can further comprise a housing which can have any shape, for example cuboidal or the shape of a cylindrical disk. In one variant, a metal foil configured as a pouch is used as housing.

Batteries according to the invention provide a very good discharge and cycling behavior, in particular at high temperatures (45° C. or higher, for example up to 60° C.) in particular with respect to the capacity loss.

Batteries according to the invention can comprise two or more electrochemical cells that combined with one another, for example can be connected in series or connected in parallel. Connection in series is preferred. In batteries according to the present invention, at least one of the electrochemical cells contains at least one electrode according to the invention. Preferably, in electrochemical cells according to the present invention, the majority of the electrochemical cells contain an electrode according to the present invention. Even more preferably, in batteries according to the present invention all the electrochemical cells contain electrodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by working examples.

General:

NMP: N-methyl pyrrolidone

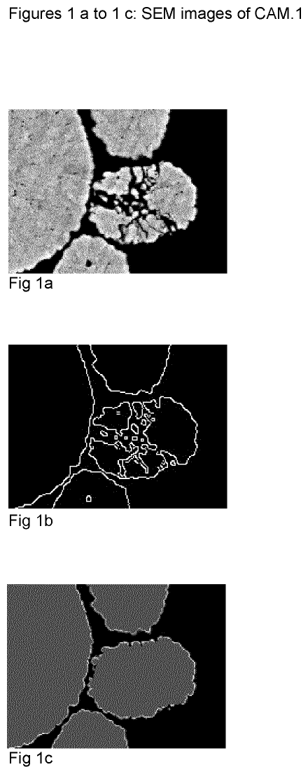

The crack level was determined as follows: the SEM pictures of arbitrarily selected particles was analyzed by an edge detection algorithm named “canny” which computed the gradient of image intensity. The algorithm applies double thresholding to determine potential edges, and track edge by hysteresis to detect final edge of object. It detects cracks inside of secondary particles and outlines of particles as edge, as, e.g., shown in FIG. 1 b. The outlines of particles are removed by eroding particle area, and remaining edges are defined as crack. Said crack pixels are normalized by particle area, which are shaded in grey in FIG. 1 c. The detected crack pixels are normalized by particle are pixels, which are shown in FIG. 10, shaded area in gray.

Percentages are % by weight unless specifically indicated otherwise.

(B.1): synthetic graphite, platelet shape, 6 μm particle diameter

I. Manufacture of inventive electrode active materials

I.1 Synthesis of a precursor TM-OH.1

A stirred tank reactor was filled with deionized water and 49 g of ammonium sulfate per kg of water. The solution was tempered to 55° C. and a pH value of 12 was adjusted by adding an aqueous sodium hydroxide solution.

The co-precipitation reaction was started by simultaneously feeding an aqueous transition metal sulfate solution and aqueous sodium hydroxide solution at a flow rate ratio of 1.8, and a total flow rate resulting in a residence time of 8 hours. The transition metal solution contained Ni, Co and Mn at a molar ratio of 8.3:1.2:0.5 and a total transition metal concentration of 1.65 mol/kg. The aqueous sodium hydroxide solution was a 25 wt. % sodium hydroxide solution and 25 wt. % ammonia solution in a weight ratio of 6. The pH value was kept at 12 by the separate feed of an aqueous sodium hydroxide solution. Beginning with the start-up of all feeds, mother liquor was removed continuously. After 33 hours all feed flows were stopped. The mixed transition metal (TM) hydroxide precursor TM-OH.1, average particle diameter (D50): 10.6 μm, was obtained by filtration of the resulting suspension, washing with distilled water, drying at 120° C. in air and sieving.

I.2 Conversion of TM-OH.1 into Cathode Active Materials

I.2.1 Manufacture of a Base Cathode Active Material, B-CAM.1, Step (a.1)

B-CAM.1 (base): The mixed transition metal hydroxide precursor TM-OH.1 was mixed with LiOH monohydrate in a Li/(TM) molar ratio of 1.03, and with TiO₂ and ZrO₂. The amounts of Ti and Zr were adjusted to obtain 0.17% Ti as well as 0.17% Zr by mole referred to the total amount of TM (TM=Ni+Co+Mn+Ti+Zr). The resultant mixture was heated to 780° C. and kept for 10 hours in a forced flow of a mixture of 60% oxygen and 40% nitrogen (by volume).

After cooling to ambient temperature, the resultant powder was deagglomerated and sieved through a 32 μm mesh to obtain the base cathode active material B-CAM 1.

D50=10.6 μm determined using the technique of laser diffraction in a Mastersize 3000 instrument from Malvern Instruments. Residual moisture at 250° C. was determined to be 300 ppm. Specific surface (BET): 0.17 m²/g.

I.2.2 Mixing with Carbon (B), Step (b.1)

B-CAM.1 and (B.1) were mixed in a weight ratio of 100:3 at ambient temperature in a bottle on a roller mixer for one hour. A mixture was obtained.

I.2.3 Exposure to Pressure, Step (c.1)

An amount of 5 g of a mixture obtained from step (b.1) was filled into a pellet press, inner diameter 16.07 mm, and pressed at 150 MPa for 10 seconds. The pressure was then released and the tablet-shaped body formed under the pressure was removed from the tablet press, gently delumped and sieved through a 32 μm vibrational screen. A free-flowing powder of CAM.1 was obtained. By image analysis, a crack level of 5.9 was determined.

I.2.4 Exposure to Pressure, Step (c.2)

An amount of 5 g of a mixture obtained from step (b.1) was filled into a pellet press, inner diameter 16.07 mm, and pressed at 300 MPa for 10 seconds. The pressure was then released and the tablet-shaped body formed under the pressure was removed from the tablet press, gently delumped and sieved through a 32 μm vibrational screen. A free-flowing powder of CAM.2 was obtained. By image analysis, a crack level of 21.1 was determined.

II. Manufacture of Electrodes

II.1 Cathode Manufacture, Steps (d) and (e)

Step (d.1) and (d.2) and C-(d.3): PVDF binder (Solef® 5130) was dissolved in NMP (Merck) to produce an 8.0 wt. % solution. For electrode preparation, binder solution (4 wt. %), and carbon black (Li250, 3.5 wt.-%) were suspended in NMP. After mixing using a planetary centrifugal mixer (ARE-250, Thinky Corp.; Japan), either any of inventive CAM.1 (step (d.1) or CAM.2 (step (d.2) or base cathode active material B-CAM.1, step C-(d.3), (92.5 wt. %) was added and the suspension was mixed again to obtain a lump-free slurry. The solid content of the slurry was adjusted to 65%.

Step (e.1): The slurry from (d.1) was coated onto Al foil using a KTF-S roll-to-roll coater (Mathis AG).

Step (e.2): The slurry from (d.2) was coated onto Al foil using a KTF-S roll-to-roll coater (Mathis AG).

Step C-(e.3): The slurry from C-(d.1) was coated onto Al foil using a KTF-S roll-to-roll coater (Mathis AG).

Electrode coating corresponded to 15 mg/cm². All electrodes were dried at 120° C. for 7 hours before battery assembly.

II.2 Electrolyte Manufacture

A base electrolyte composition was prepared containing 12.7 wt % of LiPF₆, 26.2 wt % of ethylene carbonate (EC), and 61.1 wt % of ethyl methyl carbonate (EMC) (EL base 1), based on the total weight of EL base 1. To this base electrolyte formulation 2 wt. % of vinylene carbonate (VC) was added (EL base 2).

II.3 TEST CELL MANUFACTURE

Coin-type half cells (20 mm in diameter and 3.2 mm in thickness) comprising a cathode prepared as described under III.1.1 and lithium metal as working and counter electrode, respectively, were assembled and sealed in an Ar-filled glove box. In addition, the cathode and anode and a separator were superposed in order of cathode//separator//Li foil to produce a half coin cell. Thereafter, 0.15 mL of the EL base 1 which is described above (III.2) were introduced into the coin cell.

III. Evaluation of Coin Half-Cell Performance

Cell performance were evaluated using the produced coin type battery. For the battery performances, initial capacity and reaction resistance of cell were measured. The initial performance and rate performance were measured as follows: Coin half cells according to II.3.1 were tested in a voltage range between 4.3 V to 3.0 V at 25° C. For the initial cycles, the initial lithiation was conducted in the CC-CV mode, i.e., a constant current (CC) of 0.1 C was applied until reaching 0.01 C. Reductive lithiation was carried out at constant current of 0.1 C up to 3.0V. After formation cycle, rate property was measured with 3 C discharge. Relative rate performance[%] is based on discharge capacity at 0.1 C. The results are summarized in Table 1.

Cycle performance was tested as follows; After the evaluation of initial performance, the coin cells were cycled with 0.5 C-CC-CV charge and 1 C CC discharge at 25 deg. Direct current internal resistance (“DCIR”) was measured at before and after cycle, by applying 0.5 C discharge for 30 seconds at state of charge 50%. Cycle retention and DCIR increase are based on those of before cycle as 100%. The results are summarized in Tables 1 and 2.

TABLE 1
Cell initial performance

| | Crack | 1^{st} discharge capacity | Rate performance |
|---|---|---|---|
| Sample | level | [mA · h/g] | [%] |
| CAM.1 | 5.9 | 195.8 | 87.0 |
| CAM.2 | 21.1 | 197.5 | 87.2 |
| B-CAM.1 | 1.7 | 193.2 | 85.9 |

TABLE 2
Cell cycle performance

| Sample | Cycle retention | DCIR increase |
|---|---|---|
| CAM.1 | 92.0 | 179.3 |
| CAM.2 | 92.0 | 171.5 |
| B-CAM.1 | 92.1 | 187.6 |

1-15. (canceled)

16. A process for making an electrode comprising:
(a) providing a lithiated transition metal oxide according to the formula Li₁₊ₓTM₁₋ₓO₂, wherein x ranges from zero to 0.1 and TM contains nickel and at least one of Co, Mn and Al,
(b) mixing the lithiated transition metal oxide from step (a) with carbon in electrically conductive form,
(c) exposing the mixture obtained in step (b) to a pressure ranging from 100 MPa to 500 MPa over a period of time ranging from one second to one minute, thereby causing cracks in at least some of the particles of the electrode active material,
(d) mixing the mixture from step (c) with a binder polymer and, optionally, with further carbon in electrically conductive form and with a solvent, and
(e) applying the mixture from step (d) to a metal foil.

17. The process according to claim 16, wherein TM is a combination of elements according to general formula (I)
(NiₐCo_{b}Mn_{c})_{1-d}M¹_{d} (I)
wherein
a ranges from 0.6 to 1.0,
b ranges from zero to 0.2,
c ranges from zero to 0.2, and
d ranges from zero to 0.1,
M¹ is selected from Al, Ti, Zr, W, Nb, Ta, Mo, Mg and combinations of at least two of the aforementioned,
a+b+c=1, and
at least one of b, c and d is greater than zero.

18. The process according to claim 16, wherein in step (b), carbon in electrically conductive form is graphite.

19. The process according to claim 18, wherein in step (b), a weight ratio of electrode active material provided in step (a) and graphite ranges from 100:1 to 20:1.

20. The process according to claim 16, wherein step (c) is performed in an isostatic pressing device.

21. A particulate electrode active material according to the formula Li₁₊ₓTM₁₋ₓO₂, wherein x ranges from zero to 0.1 and TM contains nickel and at least one of Co, Mn and Al wherein at least 25% of all particles have a crack level ranging from 5 to 30 and wherein the cracks contain carbon in electrically conductive form, wherein the crack level is determined by SEM picture(s) analyzed by an edge detection algorithm computing a gradient of image intensity to detect the cracks.

22. The particulate electrode active material according to claim 21, wherein TM is a combination of elements according to general formula (I)
(NiₐCo_{b}Mn_{c})_{1-d}M¹_{d} (I)
wherein
a ranges from 0.6 to 1.0,
b ranges from zero to 0.2,
c ranges from zero to 0.2, and
d ranges from zero to 0.1,
M¹ is selected from Al, Ti, Zr, W, Nb, Ta, Mo, Mg and combinations of at least two of the aforementioned,
a+b+c=1, and
at least one of b, c and d is greater than zero.

23. The particulate electrode active material according to claim 21, wherein the cracks are virtually free from binder polymer.

24. The particulate electrode active material according to claim 21, wherein at least 60% of the particles of the electrode active material show cracks.

25. The particulate electrode active material according to claim 21, wherein:
a ranges from 0.75 to 0.95,
b ranges from 0.025 to 0.125,
c ranges from 0.025 to 0.125, and
d ranges from zero to 0.1, and
M¹ selected from Al, Ti and Zr.

26. A cathode comprising:
(A) at least one particulate electrode active material according to claim 21,
(B) at least one binder and, optionally,
(C) further carbon in electrically conductive form.

27. An electrochemical cell comprising:
(1) a cathode according to claim 26,
(2) an anode, and
(3) an electrolyte.

28. An electrochemical cell according to claim 27, wherein the electrolyte is selected from electrolytes that are solid at ambient temperature and that contain sulfur and phosphorus.

29. The electrochemical cell according to claim 28, wherein the electrolyte is selected from the group consisting of Li₂S—P₂S₅, Li₂S—P₂S₅—LiI, Li₂S—P₂S₅—Li₂O, Li₂S—P₂S₅—Li₂O—LiI, Li₂S—SiS₂—P₂S₅—LiI, Li₂S—P₂S₅—ZₘSₙ wherein m and n are positive numbers and Z is a member selected from the group consisting of germanium, gallium and zinc, Li₂S—SiS₂—Li₃PO₄, Li₂S—SiS₂—Li_{y}PO_{z}, wherein y and z are positive numbers, Li₇P₃S₁₁, Li₃PS₄, Li₁₁S₂PS₁₂, Li₇P₂S₈I, and Li₇₋ᵣ₋₂ₛPS₈₋ᵣ₋ₛX¹ᵣ wherein X¹ is chlorine, bromine or iodine, and wherein:
0.8≤r≤1.7
0≤s≤(−0.25r)+0.5.
